(19) United States
(12) Patent Application Publication
(10) Pub. No.: US 2003/0190009 A1
(43) Pub. Date: Oct. 9, 2003

(54) Liquid crystal display with a built-in X-ray film reader

(76) Inventor: Chiun-Fu Yu, Taoyuan City (TW)

Correspondence Address: Keith Kline, PRO-TECHTOR INTERNATIONAL SERVICES, 20775 Norada Court, Saratoga, CA, 95070-3018, US

(21) Appl. No.: 10/301,146

(22) Filed: Nov. 20, 2002

(30) Foreign Application Priority Data
Apr. 4, 2002 (TW) 91204333

(51) Int. Cl. G01T 1/00; G01N 23/00

(52) U.S. Cl. 378/1

(57) ABSTRACT

A liquid crystal display includes a casing, a frame mounted in the casing, a support mounted in the frame, a motor, and a tray. The casing includes a front plate for holding a display screen and a rear cover attached to the front plate. The rear cover includes a lower casing portion having a side opening. The support mounted is slidable through the side opening so as to be located between an extended position out of the casing and a retracted position in the casing. The support includes a receiving space for receiving a backlight and a drive circuit for the backlight. The motor moves the support to the extended position or the retracted position. The tray is removably received in the receiving space of the support and includes a portion for receiving an X-ray film.

### BACKGROUND OF THE INVENTION

1. Field of the Invention

The present invention relates to a liquid crystal display with a built-in X-ray film reader. In particular, the present invention relates to a liquid crystal display having an X-ray film reader built therein, allowing easy placement and removal of an X-ray film.

2. Description of the Related Art

It is not uncommon to use X-ray films in a dental therapy department or unit. A typical X-ray reader is an independent reading apparatus including a support that can be controlled to move rectilinearly. A backlight and a drive circuit for the backlight are mounted on a front section of the support. A CCD (charge-coupled camera) is provided to read an X-ray film placed on the support, and an image of the X-ray film is transmitted via a conductive wire to a computer screen for reading. However, such an X-ray reader has several drawbacks including: occupation of a considerable space, requirement of a conductive wire, and inconvenience to use and installation. Further, the residual rising/developing solution on the X-ray film would corrode the backlight such that the X-ray film could not be used unless it is completely dry. Yet drying of the X-ray film takes time, and it is inconvenient to operation of the reader. Further, it is not easy to remove the X-ray film from the backlight of the X-ray film reader.

### SUMMARY OF THE INVENTION

An object of the present invention is to provide a liquid crystal display having an X-ray film reader built therein, reducing the space occupied by the liquid crystal display and improving operational convenience.

Another object of the present invention is to provide a liquid crystal display having an X-ray film reader built therein, preventing the backlight from being damaged by the residual rising/developing solution on the X-ray film.

A further object of the present invention is to provide a liquid crystal display having an X-ray film reader built therein, allowing easy placement and removal of an X-ray film.

A liquid crystal display in accordance with the present invention comprises:

a casing including a front plate for holding a display screen and a rear cover attached to the front plate, the rear cover including a lower casing portion having a side opening;

a frame mounted in the casing;

a support mounted in the frame and slidable through the side opening so as to be located between an extended position out of the casing and a retracted position in the casing, the support including a receiving space for receiving a backlight and a drive circuit for the backlight;

a motor for moving the support to one of the extended position and the retracted position; and

a tray removably received in the receiving space of the support, the tray including a portion for receiving an X-ray film.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a liquid crystal display with an X-ray film reader in accordance with the present invention.

FIG. 2 is a perspective view of the liquid crystal display in FIG. 1, wherein an outer casing of the liquid crystal distal is removed to show the interior structure.

FIG. 3 is a partly exploded perspective view similar to FIG. 2, wherein a support is in an extended position.

FIG. 4 is a sectional view of the liquid crystal display in FIG. 3.

FIG. 5 is a sectional view similar to FIG. 4, wherein the support is in a retracted position.

FIG. 6 is a sectional view of the liquid crystal display in FIG. 2.

FIG. 7 is partial exploded perspective view illustrating a side cover of the liquid crystal display.

### DETAILED DESCRIPTION OF THE PREFERRED EMBODIMENT

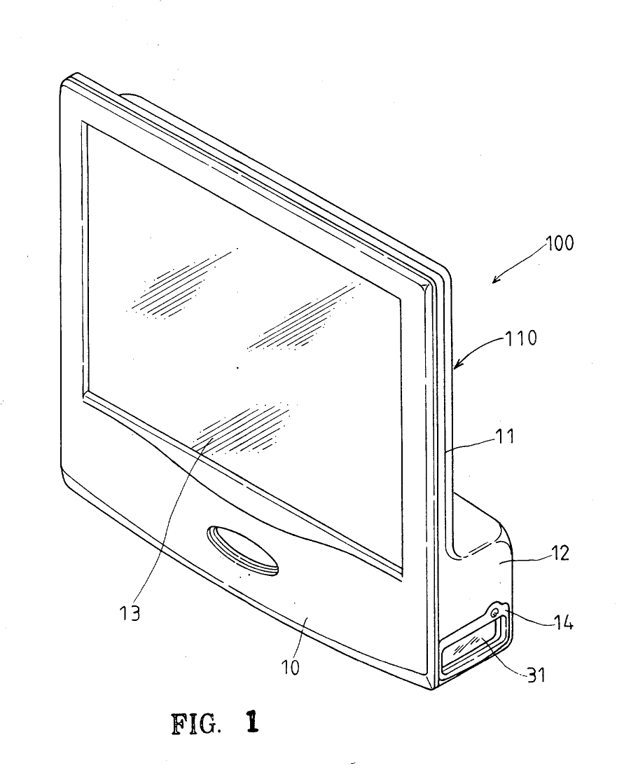

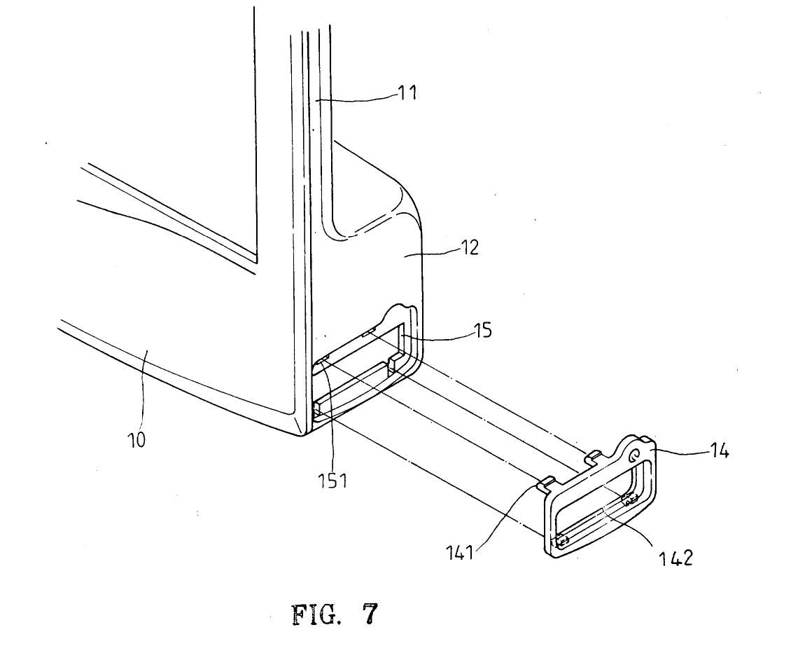

Referring to FIG. 1, a liquid crystal display 100 in accordance with the present invention generally comprises a front plate 10 and a rear cover 11, thereby constituting the whole casing 110 of the liquid crystal display 100. A liquid crystal display screen 13 is securely held by the front plate 10. The rear cover 11 includes a lower casing portion 12 to thereby define a space for receiving associated elements. Referring to FIG. 7, a side opening 15 is defined in a side of the lower casing portion 12, and a side cover 14 is attached to the side of the lower casing portion 12 and covers a perimeter delimiting the side opening 15. In this embodiment, the side cover 14 includes a plurality of hooks 141 for releasably engaging with engaging holes 151 defined in the perimeter delimiting the side opening 15. The side cover 14 includes an opening 142, which will be described later.

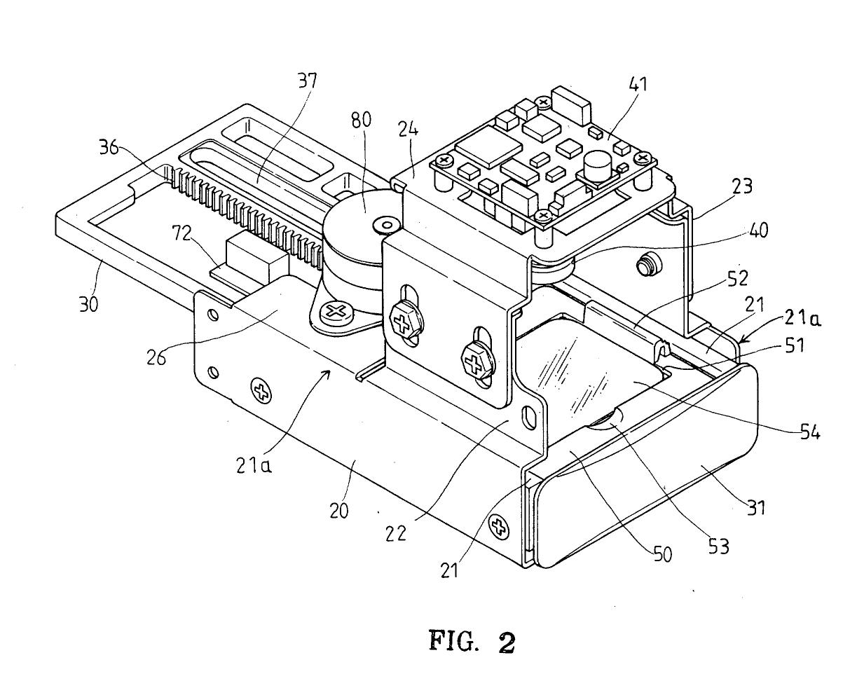

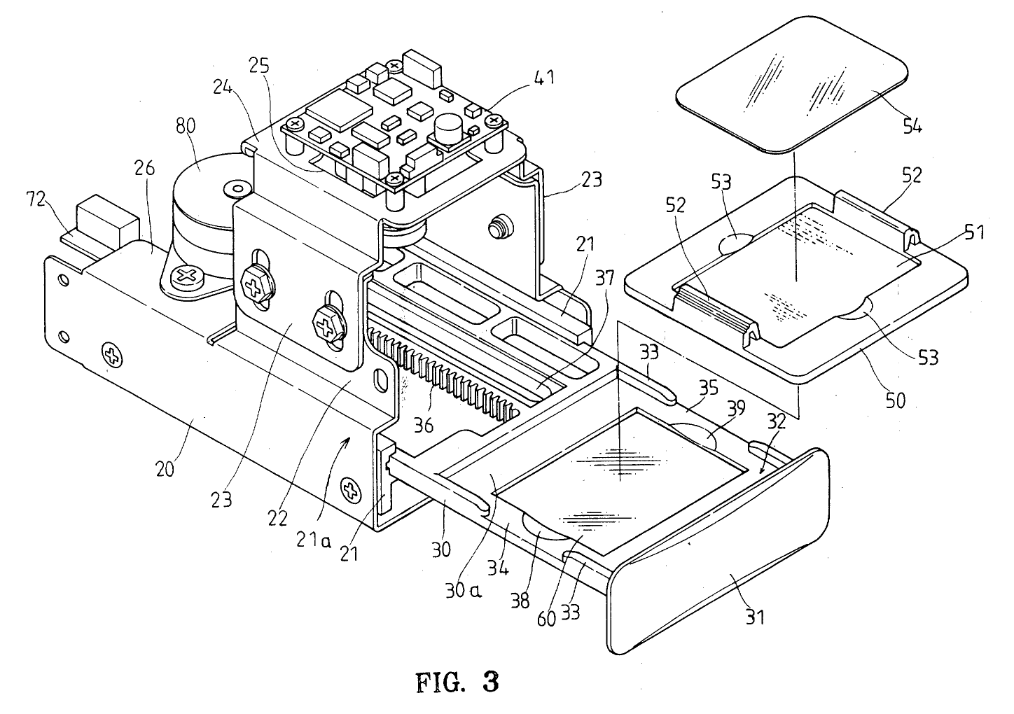

Referring to FIGS. 2 and 3, a frame 20 in the form of a hollow box is mounted in the space defined by the front plate 10 and the lower casing portion 12. A support 30 is mounted in the frame 20 and slidable between an extended position outside the liquid crystal display 100 and a retracted position inside the casing 10. A CCD (charge-coupled camera) 40 and a step motor 80 are mounted above the support 30.

In this embodiment, the frame 20 includes a pair of guide grooves 21 extending along a longitudinal direction of the frame 20 for slidingly receiving two opposed lateral sides of the support 30. The frame 20 further includes two opposed upright walls 22 extending upright from two lateral walls 21a defining the guide grooves 21. An inverted U-shaped plate 23 is securely mounted on top of the upright walls 22 and includes an opening 25 in an upper side 24 thereof. The CCD 40 and a drive circuit 41 for the CCD 40 are mounted to the inverted U-shaped plate 23, with the CCD 40 extending through the opening 25 such that a lens (not shown) of the CCD 40 faces downward. The frame 20 further includes a horizontal plate 26 on which a step motor 80 is mounted. Further, a circuit board 72 having a front photoelectric sensor 70 and a rear photoelectric sensor 71 is mounted on the horizontal plate 26.

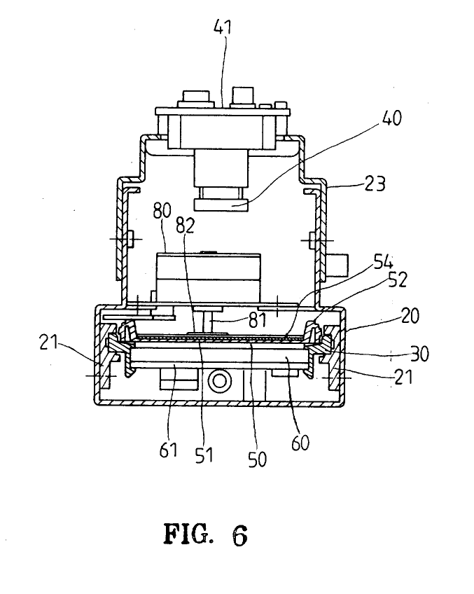

Still referring to FIGS. 2 and 3, the support 30 includes a bottom plate 30a, two opposed lateral plates 33, and an end plate 31. The bottom plate 30a and the lateral plates 33 together define a receiving space 32 for receiving a tray 50. Each lateral plate 33 includes a notch or cutout 34. A backlight 60 is mounted in an opening (not labeled) defined in the bottom plate 30a, and an illumination drive circuit 61 (see FIG. 6) is mounted below the backlight 60. Two arcuate depressions 38 and 39 are defined on two opposite sides of the backlight 60 and located adjacent to the cutouts 34, allowing easy removal of the backlight 60.

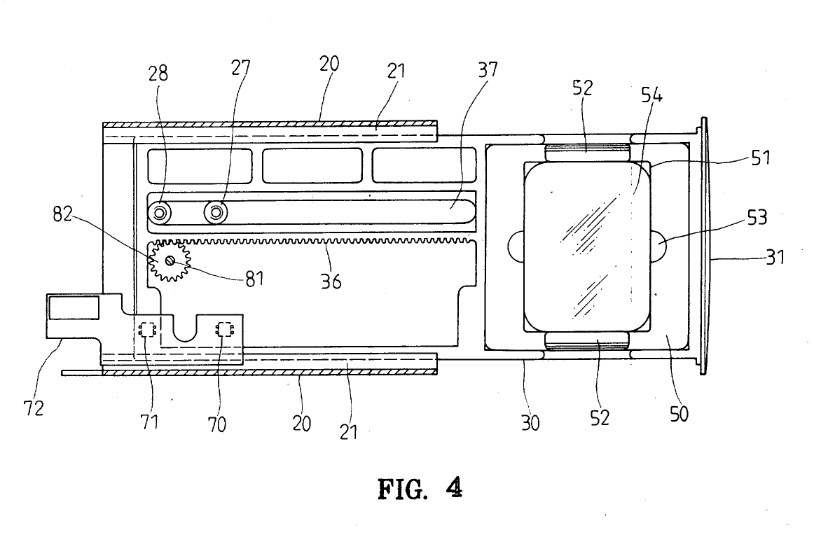

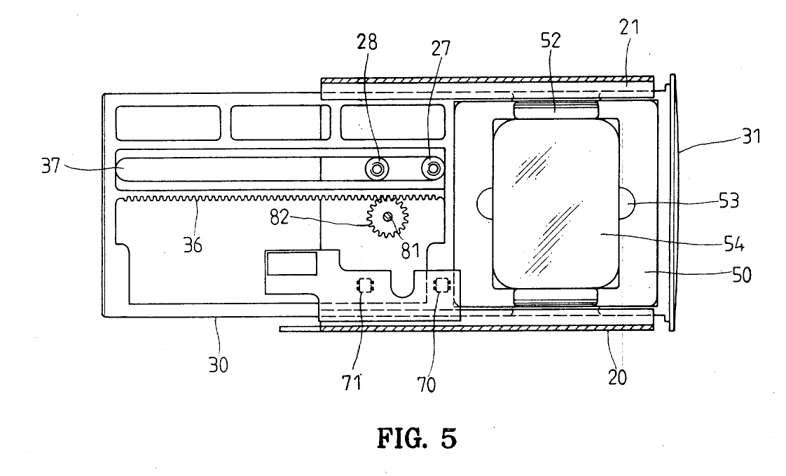

The support 30 includes a rack 36 and an elongated guide groove 37, both extending along a longitudinal direction of the support 30, which is parallel to the longitudinal direction of the frame 20. As illustrated in FIGS. 2 and 5, the rack 36 meshes with a gear 82 driven by an output shaft 81 of the step motor 80. Thus, when the step motor 80 is activated, the gear 82 is driven to thereby move the support 30 to the extended position shown in FIG. 4 or to the retracted position shown in FIG. 5. In order to control movement of the support 30, a front positioning post 27 and a rear positioning post 28 are provided in the elongated guide groove 37 to cooperate with the front and rear photoelectric sensors 70 and 71. Thus, outward and rearward movements of the support 30 and the operational time of the step motor 80 can be controlled, which is conventional and therefore not described in detail.

Still referring to FIGS. 2 and 3, the tray 50 removably received in the receiving space 32 of the support 30 is made of transparent or translucent material such as acrylic. The tray 50 includes a recessed portion 51 for receiving an X-ray film 54. The tray 50 further includes a pair of grips 52 on two opposed sides of the recessed portion 51, allowing the user to grasp the grips 52 and thus remove the tray 50 out of the receiving space 32 of the support 30. Two arcuate depressions 53 are provided on the other two opposed sides of the recessed portion 51, allowing easy removal of the X-ray film 54 from the recessed portion 51. The user may use as many trays 50 as he or she wishes, as the cost for manufacturing the tray 50 is low.

In use, an X-ray film 54 is placed in the recessed portion 51 of the tray 50 which is placed in the receiving space 32 of the support 30 located in the extended position shown in FIG. 4. The step motor 80 is activated to move the support 30 inward to the retracted position shown in FIGS. 2, 5, and 6. The illumination drive circuit 61 below the backlight 60 is activated, and the CCD 40 takes the image of the X-ray film 54 for proceeding with image processing. The resultant enlarged image is outputted to and displayed in the display screen 13. After use, the support 30 is moved to the extended position shown in FIG. 4 to allow removal of the X-ray film 54 from the tray 50 or removal of the tray 50 from the support 30. It is noted that the opening 142 of the side cover 14 allows inward and outward movement of the support 30 into and out of the casing 110.

According to the above description, it is appreciated that an X-ray film reader is successfully incorporated into a liquid crystal display and thus largely reduces the overall volume. The operation of the liquid crystal display is easy. Further, the X-ray film 54 and the backlight 60 are isolated from each other during operation such that the backlight 60 would not be damaged by the residual rising/developing solution on the X-ray film.

Although the invention has been explained in relation to its preferred embodiment, it is to be understood that many other possible modifications and variations can be made without departing from the scope of the invention as hereinafter claimed.

What is claimed is:

1. A liquid crystal display comprising:
a casing including a front plate for holding a display screen and a rear cover attached to the front plate, the rear cover including a lower casing portion having a side opening;
a frame mounted in the casing;
a support mounted in the frame and slidable through the side opening so as to be located between an extended position out of the casing and a retracted position in the casing, the support including a receiving space for receiving a backlight and a drive circuit for the backlight;
a motor for moving the support to one of the extended position and the retracted position; and
a tray removably received in the receiving space of the support, the tray including a portion for receiving an X-ray film.

2. The liquid crystal display as claimed in claim 1, wherein the support includes a bottom plate, two opposed lateral plates, and an end plate, thereby together defining the receiving space for receiving the tray.

3. The liquid crystal display as claimed in claim 1, wherein the motor includes an output shaft and a gear mounted on the output shaft, the support including a rack meshed with the gear.

4. The liquid crystal display as claimed in claim 3, wherein the frame includes a horizontal plate on which the motor is mounted, with the output shaft of the motor and the gear facing downward.

5. The liquid crystal display as claimed in claim 4, wherein the support includes an elongated guide groove, a front positioning post and a rear positioning post being received in the elongated guide groove, and a front photoelectric sensor and a rear photoelectric sensor being mounted on the horizontal plate of the frame.

6. The liquid crystal display as claimed in claim 1, wherein the portion of the tray for receiving the X-ray film is a recessed portion.

7. The liquid crystal display as claimed in claim 6, wherein the tray includes two grips on two opposed sides of the recessed portion, and wherein the tray includes two arcuate depressions on another two opposed sides of the recessed portion.

8. The liquid crystal display as claimed in claim 1, wherein the frame includes two upright walls and an inverted U-shaped plate securely mounted on top of the upright walls, a charge-coupled camera and a circuit for the charge-coupled camera being mounted on the inverted U-shaped plate.

9. The liquid crystal display as claimed in claim 8, wherein the inverted U-shaped plate includes an opening through which the charge-coupled camera extends, with a lens of the charge-coupled camera facing downward.
